(19) United States
(12) Patent Application Publication
(10) Pub. No.: US 2020/0238847 A1
(43) Pub. Date: Jul. 30, 2020

(54) SYSTEM TO PRIORITIZE POWER DELIVERY FROM A CHARGING STATION TO ELECTRIC VEHICLE

(71) Applicant: General Electric Company, Schenectady, NY (US)

(72) Inventors: Willard Monten WISEMAN, Amsterdam, NY (US); Honggang WANG, Clifton Park, NY (US)

(21) Appl. No.: 16/256,242

(22) Filed: Jan. 24, 2019

(51) Int. Cl. B60L 53/65; B60L 53/30; B60L 53/66; B60L 53/67; B60L 53/68; H02J 7/04; H02M 3/07

(52) U.S. Cl. CPC B60L 53/65; B60L 53/305; B60L 53/665; H02J 7/0027; B60L 53/68; H02J 7/042; H02M 3/07; B60L 53/67

(57) ABSTRACT

Some embodiments provide a system to prioritize power delivery from a charging station to electric vehicles. The charging station may include a communication port to receive a charge request from an electric vehicle associated with a delta platform certificate. The charging station may evaluate the delta platform certificate to determine if the electric vehicle is associated with a prioritized charging category (e.g., if the vehicle is an ambulance, police care, fire truck, etc.). A constrained optimizer may allocate power to the electric vehicle, relative to other electric vehicles being charged at the charging station, based at least in part on said determination. A charge pump may then provide power to the electric vehicle in accordance with a result from the constrained optimizer.

### BACKGROUND

An electric vehicle charging infrastructure may receive power (e.g., from a power grid, renewable resources, a battery, a distribution substation, etc.) and provide power to charge electric vehicles. Note that many different types of vehicles may be charged by a charging station at any given point in time. For example, the charging station might be simultaneously providing power to regular vehicles (e.g., motorcycles and passenger vehicles), ambulances, police vehicles, etc. Also note that the total amount of power received by a charging station (and/or that the charging station is able to deliver) might be limited. For example, a local battery and/or distribution substation might only be able to provide a fixed maximum amount of power.

In some cases, however, it might be more important to provide power to certain types of electric vehicles as compared to other types of vehicles. For example, it might be more important to quickly charge an ambulance using maximum power (e.g., so that the vehicle can return to serving patients as soon as possible) as compared to a regular vehicle or even a service vehicle (e.g., a tow truck or street sweeper). Determining what type of function a particular vehicle performs, however, can be a difficult and error prone task. Simply asking a vehicle or driver, for example, what type of vehicle is being charged might lead to false and inaccurate decisions (e.g., as people attempt to speed up the charging process). It would therefore be desirable to prioritize power delivery from a charging station in an automatic, efficient, and accurate manner.

### SUMMARY

Some embodiments described herein provide a system to prioritize power delivery from a charging station to electric vehicles. The charging station may include a communication port to receive a charge request from an electric vehicle associated with a delta platform certificate. The charging station may evaluate the delta platform certificate to determine if the electric vehicle is associated with a prioritized charging category (e.g., if the vehicle is an ambulance, police care, fire truck, etc.). A constrained optimizer may allocate power to the electric vehicle, relative to other electric vehicles being charged at the charging station, based at least in part on said determination. A charge pump may then provide power to the electric vehicle in accordance with a result from the constrained optimizer.

Some embodiments comprise: means for receiving, at an electric vehicle service point, a service request from an electric vehicle associated with a delta platform certificate; means for evaluating the delta platform certificate to determine if the electric vehicle is associated with a prioritized service category; means for executing a constrained optimizer to allocate service to the electric vehicle, relative to other electric vehicles being serviced by the service point, based at least in part on said determination; and means for providing service to the electric vehicle in accordance with a result of the constrained optimizer.

Some technical advantages of some embodiments disclosed herein are improved systems and methods using delta platform certificates to allocate service, such as charging, to electric vehicles in an automatic and accurate manner.

### BRIEF DESCRIPTION OF THE DRAWINGS

FIG. 1 is a high-level block diagram of an electric vehicle charging system according to some embodiments.

FIG. 2 is an electric vehicle service point method in accordance with some embodiments.

FIG. 3 is a block diagram of an electric vehicle charging infrastructure according to some embodiments.

FIG. 4 illustrates a charging infrastructure in accordance with some embodiments.

FIG. 5 is an example of IT and OT layer cyber hardening according to some embodiments.

FIG. 6 is a charging infrastructure display in accordance with some embodiments.

FIG. 7 is a block diagram of an electric vehicle charging infrastructure platform according to some embodiments.

FIG. 8 is a tabular portion of a prioritization database in accordance with some embodiments.

FIG. 9 is a tabular portion of a transaction database in accordance with some embodiments.

FIG. 10 is an overall system architecture illustrating relationships between charging station components according to some embodiments.

FIG. 11 is a tablet computer in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

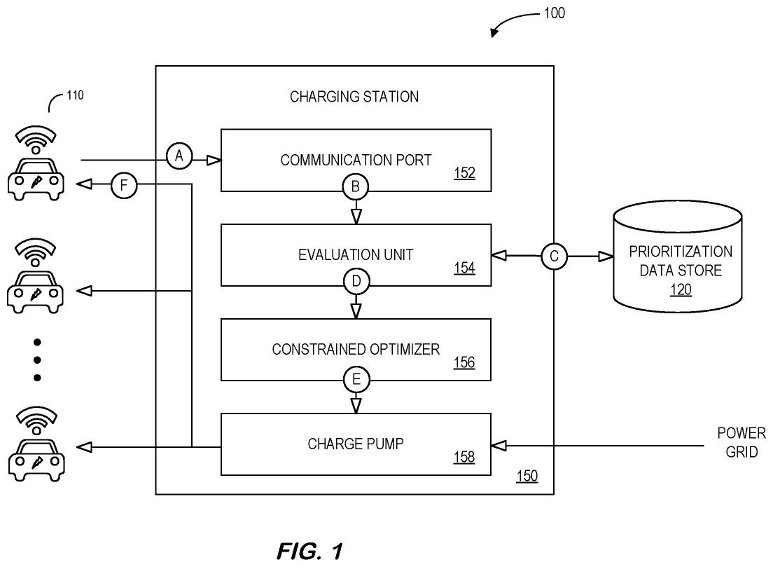

Some embodiments described herein prioritize power delivery from a charging station in an automatic, efficient, and accurate manner. For example, FIG. 1 a high-level block diagram of an electric vehicle charging system 100 according to some embodiments of the present invention. In particular, the system 100 includes a charging station 150 (e.g., associated with an enterprise such as an electric utility or town service point) receives power (e.g., from a power grid) and provides power to electric vehicles 110. The charging station 150 may access information in a prioritization data store 120 (e.g., storing a set of electronic records representing different types of vehicle categories, each record including, for example, one or more cryptographic certificates, priority weights, pricing rules, etc.). The charging station 150 may also retrieve information from other data stores or sources—such as a town database, an electric utility resource, third-party data (e.g., storing credit card information, communication addresses, motor vehicle information, etc.)—in connection with algorithms and/or models (e.g., to help prioritize power delivery in an appropriate way). The charging station 150 may also exchange information with remote devices (e.g., a workstation) associated with an operator, administrator, or an electric vehicle 110 (e.g., via a communication port 152 that might include a firewall). According to some embodiments, an interactive graphical user interface platform of the charging station 150 (and, in some cases, third-party data) may facilitate the display of information associated with the charging station 150 and/or the electric vehicles 110. Note that the charging station 150 and/or any of the other devices and methods described herein might be associated with a cloud-based environment and/or a third party, such as a vendor that performs a service for an enterprise.

The charging station 150 and/or the other elements of the system 100 might be, for example, associated with a Personal Computer (“PC”), laptop computer, smartphone, an enterprise server, a server farm, and/or a database or similar storage devices. According to some embodiments, an “automated” charging station 150 (and/or other elements of the system 100) may facilitate the prioritization of power delivery in accordance with the electronic records in the prioritization data store 120. As used herein, the term “automated” may refer to, for example, actions that can be performed with little (or no) intervention by a human.

As used herein, devices, including those associated with the charging station 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The charging station 150 may store information into and/or retrieve information from the prioritization data store 120. Other data stores may contain information about prior and current interactions with entities, including those associated with various sales transactions. The prioritization data store 120 might be locally stored or reside remote from the charging station 150. As will be described further below, the prioritization data store 120 may be used by the charging station 150 in connection with allocating power to electric vehicles 110. Although a single charging station 150 is shown in FIG. 1, any number of such devices may be included. Moreover, various devices described herein might be combined according to embodiments of the present invention. For example, in some embodiments, the charging station 150 and the prioritization data store 120 might be co-located and/or may comprise a single apparatus.

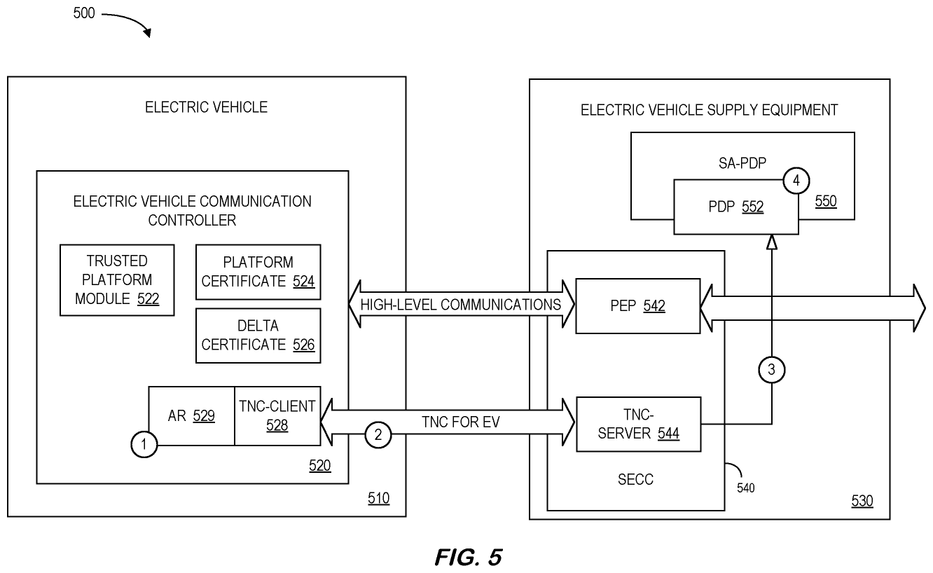

According to some embodiments, an electric vehicle 110 may transmit a charge request via the communication port 152 of the charging station 150 at (A). At (B), a delta certificate (described in more detail with respect to FIG. 5) may be provided to an evaluation unit 154. The evaluation unit 154 may use the delta certificate at (C) to determine priority information from the prioritization data store 120. The priority information may be provided to a constrained optimizer 156 at (D) which may calculate how power will be allocated among multiple electric vehicles and output the result of this allocation to a charge pump 158 at (E). The charge pump 158 may then provide power to the electric vehicles 110 as appropriate at (F).

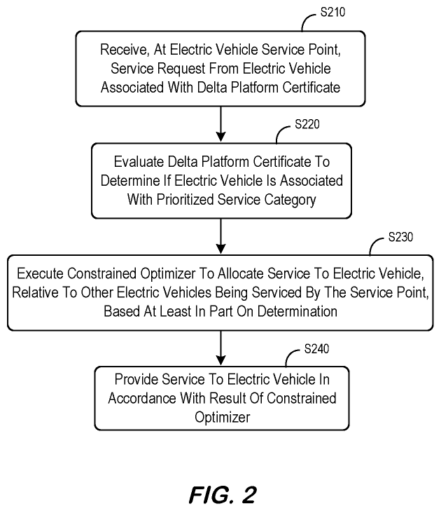

Thus, according to some embodiments, the elements of the system 100 automatically prioritize the delivery of power to electric vehicles 110. Note, however, that embodiments might be associated with providing other types of service to vehicles. For example, FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may receive, at an electric vehicle service point, a service request from an “electric vehicle” associated with a delta platform certificate. As used herein, the term electric vehicle may be associated with any type of vehicle, including, for example, a governmental vehicle, an ambulance, a fire truck, a police vehicle, a postal vehicle, a service vehicle (e.g., a tow truck or street sweeper), an autonomous vehicle, a drone, a military vehicle, etc. Moreover, although some embodiments are described with respect to the allocation of power from a charging station, note that embodiments might be associated with other types of vehicle service points. For example, a service point might be a vehicle maintenance or repair location (e.g., and a fire truck might have a flat tire fixed before a regular vehicle). Other examples might include a route access point (e.g., only ambulances are allowed through a tunnel at certain times of the day), a toll booth (e.g., cars associated with a city agency might be not be charged a toll), etc.

At S220, the system may evaluate the delta platform certificate to determine if the electric vehicle is associated with a prioritized service category. In some cases, this may be performed by accessing a prioritization data store containing a plurality of different vehicle category types, each type being associated with a prioritization weight. For example, a delivery truck for a particular enterprise may receive a higher prioritization (because the enterprise has agreed to pay a higher price for power).

At S230, the system may execute a constrained optimizer to allocate service to the electric vehicle, relative to other electric vehicles being serviced by the service point, based at least in part on the determination. The constrained optimizer might be associated with, for example, a time available to charge, a demand of charge, an amount of energy available at the charging station, a maximum power associated with a distribution transformer, etc. According to some embodiments, the constrained optimizer is associated with voltage, current, a charging rate limit, a duty ratio, a transformer temperature, a load, a visit date, a driver preference, a radio frequency identifier tag, a demand response command, weather data (e.g., a snow plow might receive a higher priority during a snow storm), pricing data, a firewall log file, a location of a public service facility (e.g., how far away is the nearest hospital or fire station?).

At S240, the system may provide service to the electric vehicle in accordance with a result of the constrained optimizer. According to some embodiments, a transaction data store may contain information about the charge request, including, for example, billing information, an agency identifier, etc. Note that some or all of the transaction data store might be stored in a secure, distributed transaction ledger (e.g., associated with blockchain technology).

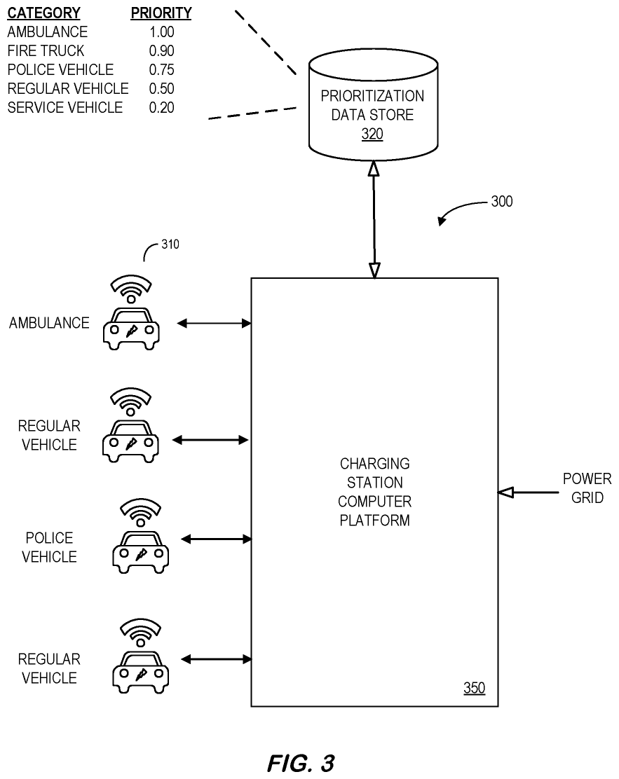

FIG. 3 is a block diagram of an electric vehicle charging infrastructure 300 according to some embodiments. As before, the system 300 includes a charging station computer platform 350 (e.g., associated with an enterprise such as an electric utility or town service point) that receives power (e.g., from a power grid) and provides power to electric vehicles 310. The charging station computer platform 350 may access information in a prioritization data store 320 (e.g., storing a set of electronic records representing different types of vehicle categories, each record including, for example, one or more cryptographic certificates, priority weights, pricing rules, etc.). As illustrated in FIG. 3, the prioritization data store 320 may include vehicle categories of ambulance, fire truck, police vehicle, regular vehicle, service vehicle, etc. with each category being associated with a priority value (from 0 to 1 in the example of FIG. 3). When various combinations of electric vehicles 310 are being simultaneously charged by the charging station computer platform 350, power may be allocated to each vehicle 310 based on the information in the prioritization data store 320. For example, the ambulance might receive power more quickly as compared to a police vehicle (which, in turn, might be receiving power more quickly as compared to a regular vehicle).

The ensure that the electric vehicles 310 are receiving appropriate amounts of power, the charging station computer platform 350 may use various techniques to verify the identity and appropriate category for each vehicle 310. In general, much of a component's security properties may depend on the details of its hardware implementation. Authenticity of the hardware may be critical when deciding whether or not to trust a component. As both an electric vehicle 310 and charging station computer platform 350 may be associated with a diverse set of manufacturers (that may be privately owned), there is a possibility that counterfeit components may be encountered. Determining that a particular component is authentic (i.e., not counterfeit) may be critical when deciding whether or not it should be trusted. Relying on software to provide the hardware's identity may be insufficient because software has a proven record of being vulnerable to attacks that lead to identity forging.

Thus, a system may require proof that an electric vehicle 310 made for a general purpose (e.g., a FORD® truck) is currently being operated as a special category of vehicle (e.g., an emergency vehicle) before providing priority charging. To facilitate this determination, an authorized agency (e.g., a police department) might add a “delta” platform certificate cryptographically to an original vehicle manufacturer's platform certificate. This delta certificate may provide proof to Electric Vehicle Supplier Equipment (“EVSE”) that the vehicle is a member of the agency. This may allow the EVSE to prioritize charging or otherwise enhance the vehicle's charging capabilities. A prioritized charging process might be associated with, according to some embodiments, a regular and/or Extreme Fast Charging (“XFC”) station (with or without renewable energy resource such as a solar panel or wind turbine).

As used herein, a “platform certificate” may refer to an element that is cryptographically bound to a unique key (e.g., a Trusted Platform Module's (“TPM's”) Endorsement Key (“EK”)). The Trusted Computing Group (“TCG”) has defined a format for a platform certificate and a set of protocols to prove that the platform certificate is bound to the TPM's EK and therefore bound to a particular platform. While an EK is normally used as it is persistent and produced and signed by the TPM manufacturer which is typically trusted, anyone skilled in the art would know that any TPM key which is “fixed” to the TPM and is trusted may be used. Such a key would have similar security properties, and the term “EK” will be used herein for brevity.

The TCG is also defining a “delta” platform certificate which provides proof of a chain of custody for the platform to enable a Trusted Supply Chain (“TSC”) for a complex manufacturing chain. For example, a platform manufacturer might create a “basic” motherboard. This motherboard may be sent to a Value-Added Reseller (“VAR”) who adds to or otherwise enhances the platform (perhaps even re-branding the motherboard). However, an end user may want proof of the original motherboard manufacturer and proof of the VAR's changes. A delta platform certificate contains a unique cryptographic binding back to the original platform certificate. The delta platform certificate is signed by the agency using the electric vehicle (e.g., the police department or an authorized agent). According to some embodiments, the delta platform certificate is used to prioritize vehicle charging (instead of being used to provide a TSC. The delta platform certificate may contain other information (such as billing information) as well to provide financial information to the EVSE. Alternatively, an agency might issue a billing certificate but add to that billing certificate a unique cryptographic value binding to the billing certificate to the agency's delta platform certificate.

When an EVSE gets the appropriate classification for each connected vehicle, an overall charging site Energy Management System (“EMS”) may execute a prioritized algorithm to decide the prioritized charging rate for each vehicle. The charging site EMS might formulate this prioritization problem, for example, through a constrained optimizer. The optimizer's objective function might comprise maximizing customer demand satisfaction while also maximizing a charging station profit. According to some embodiments, constraints might include some or all of:
a time available for charging each vehicle,
a demand of charge for each vehicle in the charging station,
an amount of energy available from distributed generation (DG), such as solar and wind generation,
a maximum power that can be drawn from a distribution transformer,
a classification of each connected vehicle,
a database including pre-built prioritized type of vehicle based on its urgency for public service, and
a distance/map of locations associated with hospitals, police stations, and other critical public service facilities.

When a prioritized vehicle and a regular vehicle are both requesting charging by a charging station, the EMS may check the constraint, such as a transformer maximum power limit. If the power demand exceeds the power limit, the EMS may initiate the optimizer (using information from a prioritization data store) to determine the optimal charging rate for each vehicle.

Note that platform certificates provide cryptographic binding between a platform's hardware and the platform's manufacturer. A platform certificates is typically a X.509 certificate signed by the hardware platform's manufacturer (e.g., to provide proof of the hardware manufacturer). If used on an electric vehicle, for example, this may let EVSE determine that the vehicle's platforms are authentic (i.e., not counterfeit) before allowing communication.

Today, EVSE supplies maximum power to all electric vehicles. However, as electric vehicles become more prevalent, some EVSE might not be able to provide full power to all connected vehicles. Methods for electric vehicles to communicate with EVSE are defined (e.g., ISO 15118) and are being deployed to make the systems more intelligent. While financial and other information about the vehicle's owner may be conveyed via some form of certificate exchange in this connection, however, the information is bound to the individual and doesn't necessarily convey anything about how a vehicle is being used.

One example of such usage would be emergency vehicles. Many of these vehicles are general purpose vehicles which can be purchased by the public but are customized for a special purpose (such as a police vehicle). A police vehicle may require higher charging rates to perform their duties. In this case, the police vehicle may convey to the EVSE that it is a police vehicle and the EVSE should prioritize charging to that particular vehicle. If other vehicles are connected, this prioritization may case other non-emergency vehicles to have their charging rates reduced.

To avoid someone with the same make and model vehicle being mistaken for the emergency vehicle, the police department may issue as delta platform certificate proving that this particular vehicle (even though it is the same make and model as available to the general public) is actually an authorized emergency vehicle. This can apply to other categories of emergency vehicle such as ambulances, fire trucks, etc.

Rather than issue delta platform certificates, an agency might provide all EVSE within an area with a simple list of their vehicles (but such a list would need to be constantly updated). Similarly, billing certificates that are not bound to the platform certificate may be used. These approaches lack assurance that the billing certificate is associated with an authorized vehicle. By using delta platform certificates, some embodiments described herein may let an agency “revoke” a delta platform certificate when a vehicle is sold (and is no longer being used as an emergency vehicle) without having the vehicle's manufacturer revoke the vehicle's platform certificate. Another benefit of using revocation of delta certificates would be to have short-lived delta certificates that automatically expire (e.g., every 30 days). A benefit of short-lived delta certificates over distributing “valid” platform certificates as a prioritized database requires the electric vehicle stations to be online to keep the database current. Delta certificates might be renewed automatically when the vehicle is at the station allowing the electric vehicle station to be remote and disconnected.

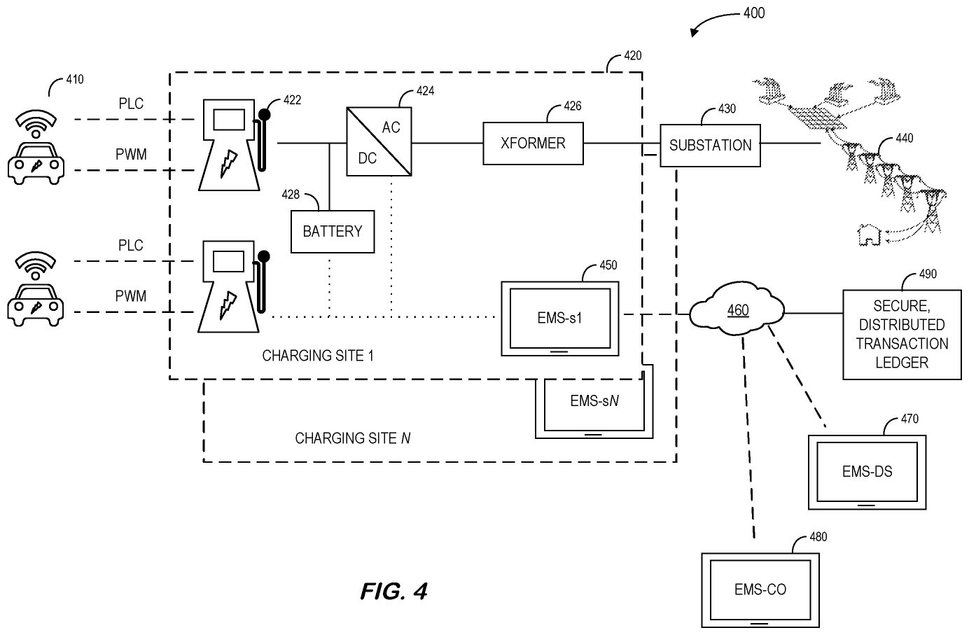

FIG. 4 is high-level architecture 400 of an Electric Vehicle (“EV”) 410 charging infrastructure cyber-physical system that might include charge pumps 422 according to some embodiments. The EV 410 and charge pumps 422 might exchange, for example, Power Line Communication (“PLC”) and/or Pulse Width Modulation (“PWM”) information. Note that EVs 410 are expected to become a major component of the power grid 440, and FIG. 4 illustrates a power topology of an XFC charging site 420. Since multiple 450 kW access points may be co-located at a single charging site 420, large variations in average and peak charging demands may exist throughout the day. For this reason, it may prove desirable to integrate local energy sources such as batteries 428 and solar generation within the charging site 420. XFCs and energy sources may typically be integrated via low voltage AC distribution. However, as the total capacity of the XFC charging site 420 increases with respect to the AC grid supply, DC distribution may become a much more economic and compact solution. As shown in FIG. 4, an XFC charging site 420 might be coupled through a DC bus.

An energy storage device, such as the battery 428, may connect to the DC bus to reduce the grid stress, accommodate distributed power generation, and/or reduce cost through demand response. An AC/DC grid-interface inverter 424 may transfer power between the shared DC bus and the AC grid feeder. Together with a transformer 426 and switchgear, the inverter 424 and shared DC bus forms one charging site 420. Using one or multiple points-of-interconnect, charging sites 420 may interface with the power grid 440 at a location downstream from a distribution substation 430 operated and controlled by a Distribution Substation Energy Management System (“EMS-DS”) 470 via a communication network 460. The EMS-DS 470 may communicate with a Charging Network Operator Controller (“EMS-CO”) 480. The EMS-CO 480 may manage each XFC directly or through an on-site EMS 450 (e.g., “EMS-s1” through EMS-sN). As will be described, the architecture 400 may include a secure, distributed transaction ledger 490 (e.g., an attestation blockchain) to record transaction information. According to some embodiments, the charging site 420 may inspect delta platform certificates submitted by EVs 410 and use that information to prioritize the provision of power from charge pumps 422.

According to some embodiments, bi-directional authentication of the electric vehicle 410 and the electric vehicle charging site 420 may be performed in connection with a charge request (and before the provision of power is prioritized). The TPM specification is published both as a TCG Specification and as International Standards Organization (“ISO”) document 11889. The TPM's capabilities include: an advanced key manager with sophisticated policies, a means to authenticate the identity of the platform's components (both physical and firmware/software), a hardware-based Random Number Generator (“RNG”), time and monotonic counters, and the ability to store relatively small amounts of policy protected critical data. The TPM's architecture supports multitenancy allowing dedicated keys, etc. owned by an Original Equipment Manufacturer (“OEM”) (e.g., the EV or EVSE) to be inaccessible to a user. This supports use cases such as an OEM using TPM feature to manage its own assets (e.g., firmware updates) without providing users access (or even visibility) to those OEM TPM assets.

The TPM has specific keys and features which enable platform identity. Note that a platform's identity is a composite of both a “hardware” identity (immutable components) and a software identity (including firmware, which is mutable, changeable, and updatable). The hardware identity may be provided by platform certificates authenticated using specific TPM keys. TPMs are widely deployed in Personal Computer (“PC”) clients, servers and many infrastructure components such as network routers and switches. TCG has a workgroup defining TPMs for industrial controllers. Operating System (“OS”) drivers and application libraries (e.g., Application Programming Interfaces (“APIs”)) are available for Windows, Linux, and other environments. Note that TCG has defined a set of TPM specifications for automotive applications. Some automotive suppliers have already added TPMs to automobile based on these specifications.

The TCG Trusted Network Connect (“TNC”) architecture (adopted by many network equipment operators) defines a set of actors to a query and evaluates and acts on a platform's claimed identity and integrity. Specifically, the architecture includes:
an Access Requestor (“AR”) representing an entity requesting access to network resources;
a Policy Decision Point (“PDP”) representing an entity making a trust decision; and
a Policy Enforcement Point (“PEP”) representing an entity that enforces the decision of the PDP.

Note that the evaluation can work both ways such as with mutual attestation (e.g., a client can be the AR and a server can be the PDP/PEP to start the connection but before continuing the client may require identity and/or attestation of the server. In this case, the server may be the AR and the client may be the PDP/PEP. Both steps may be required to be successful before communications continue.

FIG. 5 is an example 500 of Information Technology (“IT”) and Operational Technology (“OT”) layer cyber hardening in accordance with some embodiments. An electric vehicle 510 with an Electric Vehicle Communication Controller (“EVCC”) 520 may be interested in exchanging information with EVSE 530 (including a prioritized charge request). The EVCC 520 might include a TPM 522, a platform certificate 524, a delta platform certificate 526, a TNC-client 528, and an AR 529. The EVSE 530 might include a Supply Equipment Communication Controller (“SECC”) 540 (with a PEP 542 and a TNC-server 544) and a Secondary Actor Policy Decision Point (“SA-PDP”) 550 (associated with a PDP 552). As illustrated in the example 500, the following steps may occur after a physical connection is established (including a wireless connection) but before the initiation of high-level communication (including a prioritized charge request):
at (1), the EVCC 520 acts as an AR 529 requesting access to the SECC 540;
at (2), the SECC 540 requests, and the EVCC 520 responds with, the EVCC platform certificate 524,
at (3), the SECC 540 passes the platform certificate 524 and delta certificate to the SA-PDP 550, and
at (4), the SA-PDP 550 evaluates the platform's identity and category.
   The verified identity and category can then be used to make a policy decision (e.g., that an ambulance should be charged using maximum power). Note that these steps may have a step inserted before in the reverse direction. That is, FIG. 5 only illustrates the sequence where the SECC 540 is evaluating the EVCC 520. If the EVCC 520 is evaluating the SECC 540, the functions and protocols may be inverted.

Each decision by the SA-PDP 550 should preservice a part of a set of permanent transactions. Each audit transaction may include the set of inputs into the decision and the resulting actions. These transactions may be used to as an input into malware containment, anomaly detection, forensics, etc. As these systems are distributed, blockchain attestation (e.g., using the secure, distributed transaction ledger 490 of FIG. 4) may provide a distributed transaction log.

Note that the PDP 552 depicted in FIG. 5 could be either a stand-alone module or may be integrated with the decision fusion module 270 of FIG. 2. According to some embodiments, advanced policies may be possible when the PDP 552 is integrated into a decision fusion module 270. For example, the EVSE 530 anomaly detection may be relaxed if the EV 510 is determined to be trusted. Conversely, if the EV 510 trust state cannot be determined (e.g., the EV 510 doesn't support the protocol depicted FIG. 5), the EVSE 530 decision fusion module might apply stricter anomaly detection. Once the parties are authenticated, a prioritized charge request may be processed in accordance with any of the embodiments described herein.

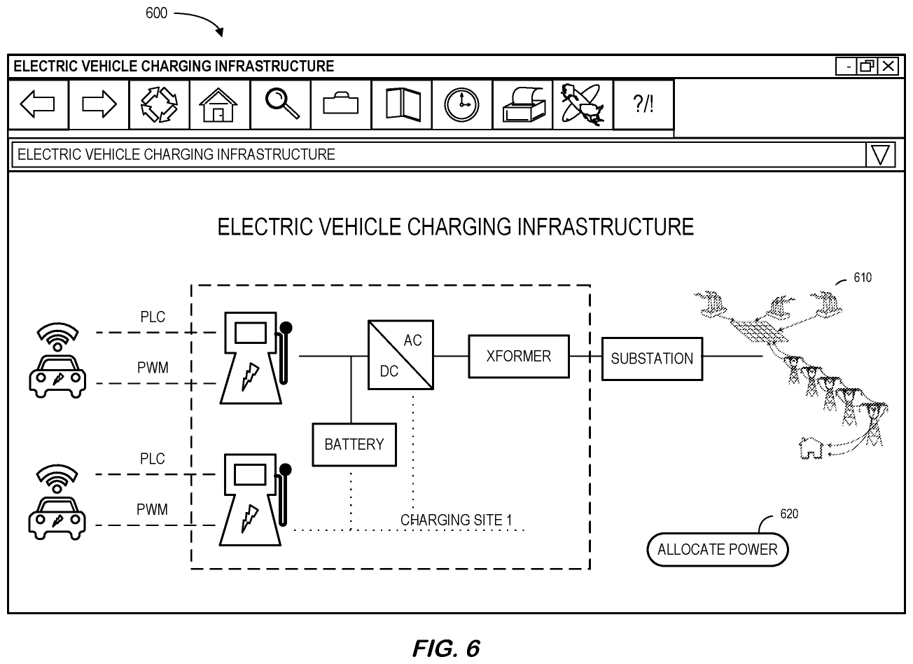

FIG. 6 is an electric vehicle charging infrastructure display 600 in accordance with some embodiments. The display 600 includes a graphical representation of an electric vehicle charging infrastructure 610 that may be used to provide power to electric vehicles. According to some embodiments, the display 600 is interactive and may be used by an operator to determine more detailed information (e.g., via pop-up window) and/or to adjust the operation of the system (e.g., via selection of an “Allocate Power” icon 620 via a touchscreen or computer mouse pointer).

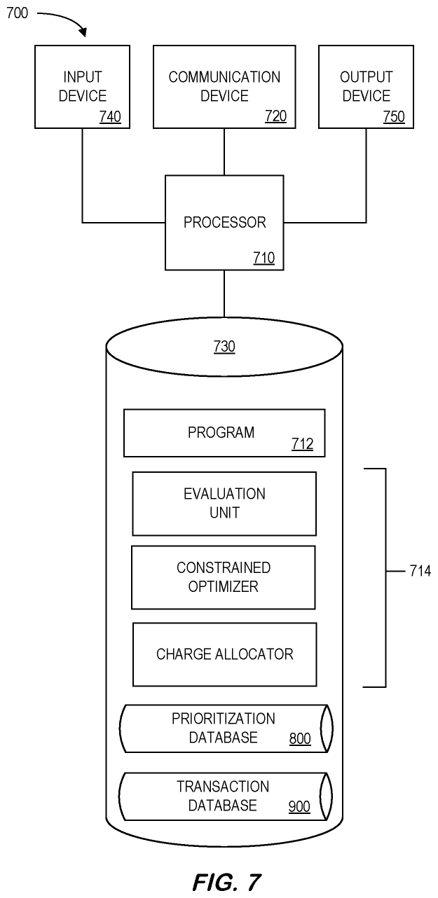

The embodiments described herein may be implemented using any number of different hardware configurations. For example, FIG. 7 is a block diagram of an electric vehicle charging station platform 700 that may be, for example, associated with the system 100 of FIG. 1. The electric vehicle charging station platform 700 comprises a processor 710, such as one or more commercially available Central Processing Units (“CPUs”) in the form of one-chip microprocessors, coupled to a communication device 760 configured to communicate via a communication network (not shown in FIG. 7). The communication device 760 may be used to communicate, for example, with one or more remote monitoring nodes, user platforms, digital twins, etc. The electric vehicle charging station platform 700 further includes an input device 740 (e.g., a computer mouse and/or keyboard to input priority information, adaptive and/or predictive modeling information, etc.) and/an output device 750 (e.g., a computer monitor to render a display, provide alerts, transmit recommendations, and/or create reports). According to some embodiments, a mobile device, monitoring physical system, and/or PC may be used to exchange information with the electric vehicle charging station platform 700.

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or modules 714 (e.g., modules associated with an evaluation unit, a constrained optimizer, and a charge allocator) for controlling the processor 710. The processor 710 performs instructions of the programs and modules 712, 714, and thereby operates in accordance with any of the embodiments described herein. For example, the processor 710 may provide a system to prioritize power delivery from a charging station to electric vehicles. The processor 710 may receive a charge request from an electric vehicle associated with a delta platform certificate. The processor 710 may evaluate the delta platform certificate to determine if the electric vehicle is associated with a prioritized charging category (e.g., if the vehicle is an ambulance, police care, fire truck, etc.). The processor 710 may allocate power to the electric vehicle, relative to other electric vehicles being charged at the charging station, based at least in part on said determination. The processor 710 may then provide power to the electric vehicle in accordance with a result from the constrained optimizer.

The programs 712, 714 may be stored in a compressed, uncompiled and/or encrypted format. The programs 712, 714 may furthermore include other program elements, such as an operating system, clipboard application, a database management system, and/or device drivers used by the processor 710 to interface with peripheral devices.

As used herein, information may be “received” by or “transmitted” to, for example: (i) the electric vehicle charging station platform 700 from another device; or (ii) a software application or module within the electric vehicle charging station platform 700 from another software application, module, or any other source.

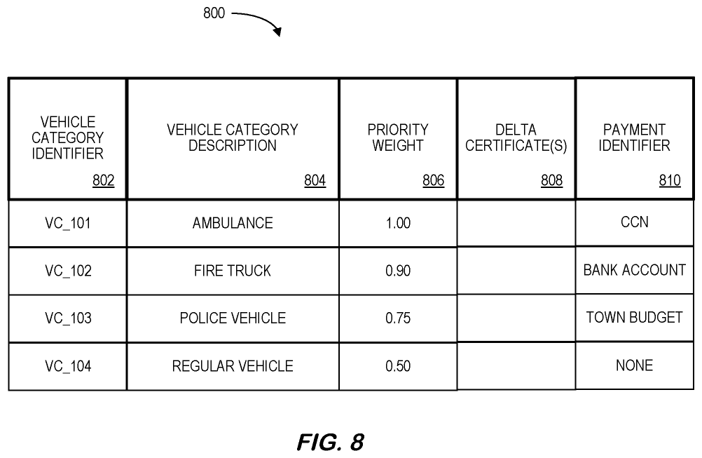

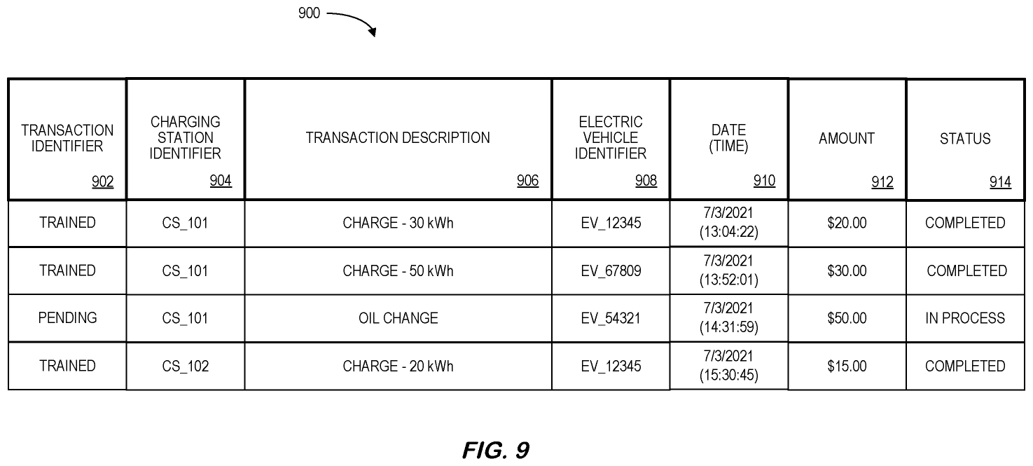

In some embodiments (such as the one shown in FIG. 7), the storage device 730 further stores a prioritization database 800 and a transaction database 900. Examples of databases that may be used in connection with the electric vehicle charging station platform 700 will now be described in detail with respect to FIGS. 8 and 9. Note that the databases described herein are only examples, and additional and/or different information may be stored therein. Moreover, various databases might be split or combined in accordance with any of the embodiments described herein.

Referring to FIG. 8, a table is shown that represents the prioritization database 800 that may be stored at the electric vehicle charging station platform 700 according to some embodiments. The table may include, for example, entries identifying electric vehicle categories. The table may also define fields 802, 804, 806, 808, 810 for each of the entries. The fields 802, 804, 806, 808, 810 may, according to some embodiments, specify: a vehicle category identifier 802, a vehicle category description 804, a priority weight 806, delta platform certificates 808, and a payment identifier. The prioritization database 800 may be created and updated, for example, when a new category of electric vehicle is added, when relative weights are adjusted, etc.

The vehicle category identifier 802 might comprise a unique alphanumeric code and the vehicle category description 804 may identify a particular usage or reason associated with vehicle operation (e.g., ambulance, fire truck). The priority weight 806 might comprise a category (e.g., high or low), rank, rule or logic, or any other information that might be used to prioritize allocation of a service in connection with a vehicle. The delta certificates indicate information that may be used to verify that a particular vehicle is, in fact, being used for the associated public purpose. The payment identifier 810 might comprise a credit card number, bank account, or any other information that can be used to facilitate a transaction with a particular class of vehicle.

Referring to FIG. 9, a table is shown that represents the transaction database 900 that may be stored at the electric vehicle charging station platform 700 according to some embodiments. The table may include, for example, entries identifying electric vehicle charging transactions. The table may also define fields 902, 904, 906, 908, 910, 912, 914 for each of the entries. The fields 902, 904, 906, 908, 910, 912, 914 may, according to some embodiments, specify: a transaction identifier 902, a charging station identifier 904, transaction description 906, an electric vehicle identifier 908, a date and time 910, an amount 912, and a status 914. The transaction database 900 may be created and updated, for example, as vehicles are charged by a charging station (or any other service is provided in connection with vehicles)

The transaction identifier 902 might comprise a unique alphanumeric code associated with a transaction between an electric vehicle and a charging stations. The charging station identifier 902, transaction description 904, and EV identifier 906 may reflect a particular transaction. The date and time 910 might indicate when the transaction occurred, and the amount 912 might indicate how much the owner of the EV paid for the electric charge. The status 914 might indicate that the transaction has been complement, is currently in process, was canceled, etc.

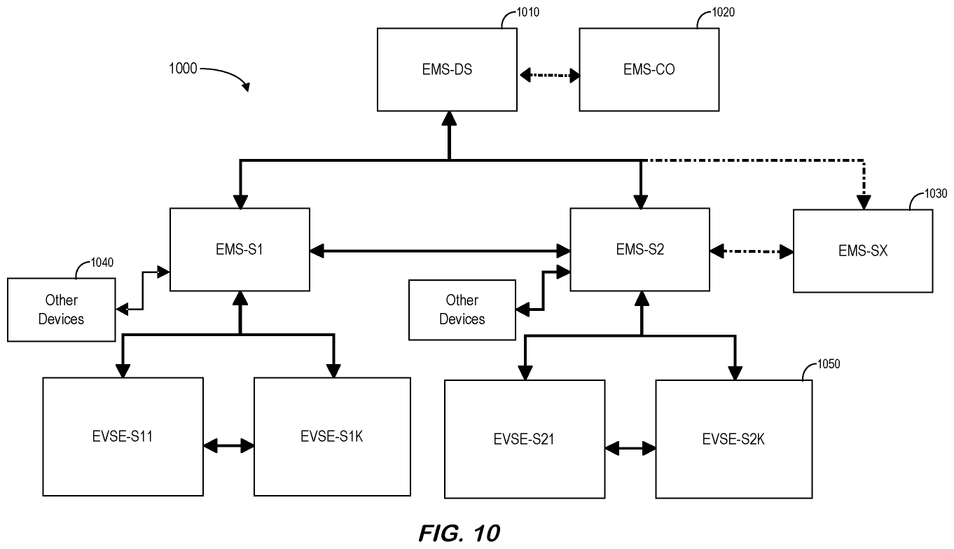

FIG. 10 is an overall system architecture 1000 illustrating relationships between charging station components in accordance with some embodiments. The architecture 1000 includes EVSE 1050, a Charging Station Energy Management System (“EMS-Si”) 1030, a Distribution Substation Energy Management System (“EMS-DS”) 1010 and a Charging Operational Energy Management System (“EMS-CO”) 1020. Normally. there is one EMS-Si 1030 in one charging station. As shown in FIG. 10, multiple EVSE 1050, together with other power equipment 1040 instrumentation inside the one charging station, may also communicate with the EMS-Si 1030. Multiple EMS-Si 1030, each managing one charging station, may be in communication with the EMS-DS 1010 and/or the EMS-CO 1020. Note that some or all of the elements of the architecture 1000 may help prioritize the allocation of power to electric vehicles during a charging process in accordance with any of the embodiments described herein.

Thus, if there are any government requirements (or voluntary decision) to prioritize charging rates for emergency or “first responder” vehicles embodiments described herein might be licensed to help implement such a system. Although platform certificates are a relatively new method for establishing a TSC, embodiments described herein use platform certificates and delta platform certificates to provide prioritization of services (such as charge rate) for electric vehicles.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

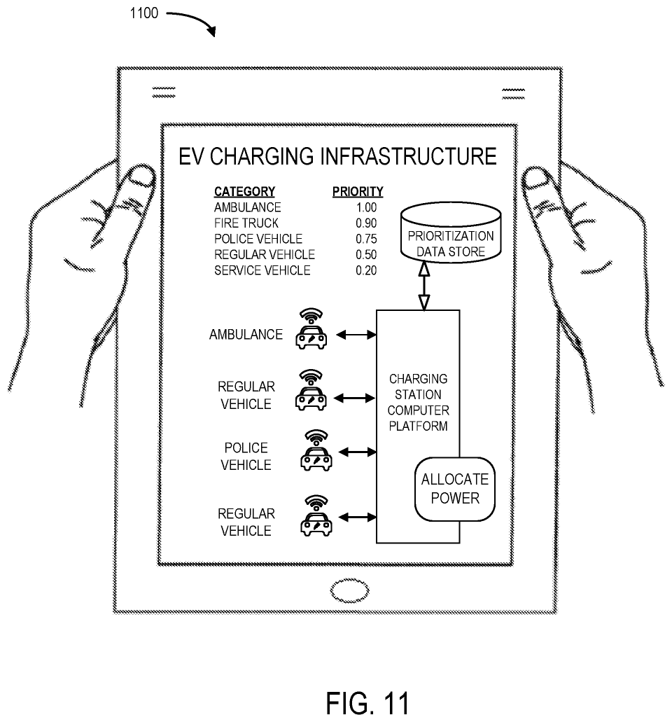

Although specific hardware and data configurations have been described herein, note that any number of other configurations may be provided in accordance with embodiments of the present invention (e.g., some of the information associated with the databases described herein may be combined or stored in external systems). Moreover, the display described here are merely exemplary and other types of displays and display devices might be used instead. For example, FIG. 11 illustrates a table computer 1100 providing an electric vehicle charging infrastructure display in accordance with any of the embodiments described herein. Selection of a portion of the display (e.g., via touchscreen) might result in a display of additional information about an element of the display, adjust operation of the charging station (e.g., by changing priority weights), etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system for an electric vehicle charging infrastructure, comprising:
an electric vehicle charging station, including:
a communication port to receive a charge request from an electric vehicle associated with a delta platform certificate,
an evaluation unit to evaluate the delta platform certificate to determine if the electric vehicle is associated with a prioritized charging category,
a constrained optimizer to allocate power to the electric vehicle, relative to other electric vehicles being charged at the charging station, based at least in part on said determination, and
a charge pump to provide power to the electric vehicle in accordance with a result from the constrained optimizer.

2. The system of claim 1, wherein the prioritized charging category is associated with at least one of: (i) a governmental vehicle, (ii) an ambulance, (iii) a fire truck, (iv) a police vehicle, (v) a postal vehicle, (vi) a service vehicle, (vii) an autonomous vehicle, (viii) a drone, and (ix) a military vehicle.

3. The system of claim 1, wherein said evaluation is associated with a Trusted Platform Module (“TPM”) platform certificate cryptographically bound to an endorsement key.

4. The system of claim 1, wherein the constrained optimizer is associated with at least one of: (i) a time available to charge, (ii) a demand of charge, (iii) an amount of energy available at the charging station, and (iv) a maximum power associated with a distribution transformer.

5. The system of claim 1, wherein the constrained optimizer is associated with at least one of: (i) voltage, (ii) current, (iii) a charging rate limit, (iv) a duty ratio, (v) a transformer temperature, (vi) a load, (vii) a visit date, (viii) a driver preference, (ix) a radio frequency identifier tag, (x) a demand response command, (xi) weather data, (xii) pricing data, (xiii) a firewall log file, and (xiv) a location of a public service facility.

6. The system of claim 1, further comprising:
a transaction data store to contain information about the charge request, including at least one of: (i) billing information, and (ii) an agency identifier.

7. The system of claim 6, wherein the transaction data store is associated with a secure, distributed transaction ledger.

8. The system of claim 1, further comprising:
a prioritization data store containing a plurality of different vehicle category types, each type being associated with a prioritization weight.

9. The system of claim 1, wherein the charge request is further associated with at least one of: (i) a trusted platform module, (ii) a hardware root of trust, (iii) platform configuration registers, (iv) a trusted network connect, and (v) a policy enforcement point.

10. The system of claim 9, wherein bi-directional authentication of the electric vehicle and the electric vehicle charging station is performed.

11. The system of claim 1, wherein the electric vehicle charging station is associated with extreme fast charging.

12. The system of claim 1, wherein the delta platform certificate is subsequently revoked, and the electric vehicle charging station determines that the electric vehicle is no longer associated with the prioritized charging category.

13. A computerized method associated with an electric vehicle infrastructure, comprising:
receiving, at an electric vehicle service point, a service request from an electric vehicle associated with a delta platform certificate;
evaluating the delta platform certificate to determine if the electric vehicle is associated with a prioritized service category;
executing a constrained optimizer to allocate service to the electric vehicle, relative to other electric vehicles being serviced by the service point, based at least in part on said determination; and
providing service to the electric vehicle in accordance with a result of the constrained optimizer.

14. The method of claim 13, wherein the electric vehicle service point is associated with at least one of: (i) a charging station, (ii) a maintenance location, (iii) a repair location, (iv) a route access point, and (v) a toll booth.

15. The method of claim 13, wherein the prioritized service category is associated with at least one of: (i) a governmental vehicle, (ii) an ambulance, (iii) a fire truck, (iv) a police vehicle, (v) a postal vehicle, (vi) a service vehicle, (vii) an autonomous vehicle, (viii) a drone, and (ix) a military vehicle.

16. The method of claim 13, wherein said evaluation is associated with a Trusted Platform Module (“TPM”) platform certificate cryptographically bound to an endorsement key.

17. The method of claim 13, wherein the constrained optimizer is associated with at least one of: (i) a time available to charge, (ii) a demand of charge, (iii) an amount of energy available at a charging station, and (iv) a maximum power associated with a distribution transformer.

18. The method of claim 13, wherein the constrained optimizer is associated with at least one of: (i) voltage, (ii) current, (iii) a charging rate limit, (iv) a duty ratio, (v) a transformer temperature, (vi) a load, (vii) a visit date, (viii) a driver preference, (ix) a radio frequency identifier tag, (x) a demand response command, (xi) weather data, (xii) pricing data, (xiii) a firewall log file, and (xiv) a location of a public service facility.

19. A non-tangible, computer-readable medium storing instructions, that, when executed by a processor, cause the processor to perform a method associated with an electric vehicle charging infrastructure, the method comprising:
receiving, at an electric vehicle charging station, a charge request from an electric vehicle associated with a delta platform certificate;
evaluating the delta platform certificate to determine if the electric vehicle is associated with a prioritized charging category;
executing a constrained optimizer to allocate power to the electric vehicle, relative to other electric vehicles being charged by the charging station, based at least in part on said determination; and
providing power to the electric vehicle in accordance with a result of the constrained optimizer.

20. The medium of claim 19, further comprising:
a transaction data store to contain information about the charge request, including at least one of: (i) billing information, and (ii) an agency identifier.

21. The medium of claim 20, wherein the transaction data store is associated with a secure, distributed transaction ledger.
